(19) United States
(12) Patent Application Publication
(10) Pub. No.: US 2026/0064489 A1
(43) Pub. Date: Mar. 5, 2026

(54) Mapping Operational Readiness of Computational Services

(71) Applicant: ServiceNow, Inc., Santa Clara, CA (US)

(72) Inventors: Darius Koohmarey, San Diego, CA (US); Kavini Mehta, Santa Clara, CA (US); Ankit Khetarpal, Los Gatos, CA (US); Marcus Alday, San Diego, CA (US)

(21) Appl. No.: 18/819,777

(22) Filed: Aug. 29, 2024

(51) Int. Cl. G06F 9/50

(52) U.S. Cl. CPC G06F 9/5083

(57) ABSTRACT

An example implementation may involve: obtaining a service map of a service deployed within a network, wherein the service map includes representations of computing resources that constitute the service and relationships between the computing resources; obtaining respective performance targets and respective actual performance data for each of the computing resources; determining, based on the respective performance targets or the respective actual performance data, that a particular computing resource is unable to meet its respective performance target; and generating a representation of a graphical user interface that depicts the service map in accordance with the relationships between the computing resources, wherein the respective performance targets and the respective actual performance data are provided for each of the computing resources.

### BACKGROUND

Modern networks may support numerous services enabled by collections of interconnected computing resources that are configured to work together to provide specific capabilities. These services may be defined based on their constituent computing resources, such as server devices and other computing infrastructure, applications, databases, and/or network elements (e.g., routers, switches, and/or load balancers). However, the operational readiness of services is often unstandardized, as the configuration enforcement, monitoring, and visibility into operation of the computing resources that constitute the service may be carried out on an ad-hoc basis if at all. As a consequence, whether any given service is actually ready for deployment or is operating correctly cannot easily be determined. This leads to a greater likelihood that a service will fail to operate properly when it is launched or thereafter, resulting in wastage of computational capacity (e.g., processing, memory, network, and/or power capacity).

### SUMMARY

Various implementations disclosed herein include improvements to the operational readiness and operational correctness of services. Deploying and operating services in a network (or across networks) can be involved and error-prone procedures due to the number of computing resources that provide the service as well as the relationships between these computing resources. Where one or more computing resources relied on by the service are not present or are misconfigured, the service is unlikely to operate correctly (if at all). Consequently, the availability of the service can be lower than desired. Further, if a service in operation fails, it may be difficult to identify the root cause. This results in the time taken for returning the service to an operational state being higher than desired.

Operational readiness involves a set of procedures and/or computing operations that specify the readiness of a service for deployment. Determining operational readiness may involve a number of steps including: obtaining a service map of the service (e.g., by way of the service mapping procedures or some other means), identifying a readiness of each of the computing resources constituting the service (e.g., by performing a predefined list of checks on the computing resources), and generating a display of the readiness of each computing resource in the service map (e.g., for display on a graphical user interface). Particularly, the respective readiness of each computing resource can be considered in various combinations to determine a health score for the service that is an indicator of the service's overall operational readiness.

Operational correctness involves two distinct but related procedures: (i) determining dependencies between computing resources in a service map and whether the dependency structure allows performance targets to be achieved, and (ii) tracking actual performance of the computing resources and comparing these to the performance targets.

Alone or in combination, the operational readiness and operational correctness procedures described herein reduce wastage of computational capacity (e.g., processing, memory, network, and/or power capacity) by lowering the likelihood of an unsuccessful service launch, as well as proactively determining performance data of computing resources.

Accordingly, a first example embodiment may involve obtaining a service map of a service deployed within a network, wherein the service map includes representations of computing resources that constitute the service and relationships between the computing resources; determining respective measurements of operational readiness for each of the computing resources, wherein the respective measurements of operational readiness are based on a set of checks involving configurable aspects of the computing resources; and generating a representation of a graphical user interface that depicts the service map in accordance with the relationships between the computing resources, wherein the respective measurements of operational readiness are provided for each of the computing resources.

A second example embodiment may involve obtaining a service map of a service deployed within a network, wherein the service map includes representations of computing resources that constitute the service and relationships between the computing resources; obtaining respective performance targets and respective actual performance data for each of the computing resources; determining, based on the respective performance targets or the respective actual performance data, that a particular computing resource is unable to meet its respective performance target; and generating a representation of a graphical user interface that depicts the service map in accordance with the relationships between the computing resources, wherein the respective performance targets and the respective actual performance data are provided for each of the computing resources.

A third example embodiment may involve a non-transitory computer-readable medium, having stored thereon program instructions that, upon execution by a computing system, cause the computing system to perform operations in accordance with any of the previous example embodiments.

In a fourth example embodiment, a computing system may include at least one processor, as well as memory and program instructions. The program instructions may be stored in the memory, and upon execution by the at least one processor, cause the computing system to perform operations in accordance with any of the previous example embodiments.

In a fifth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a service map, in accordance with example embodiments.

FIG. 7 depicts a service map displaying operational readiness of computing resources, in accordance with example embodiments.

FIGS. 8A and 8B depict different types of dependency relationships between computing resources, in accordance with example embodiments.

FIG. 9 depicts a service map displaying performance targets and performance data of computing resources, in accordance with example embodiments.

FIG. 10A is a flow chart, in accordance with example embodiments.

FIG. 10B is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is loss of computational capacity (e.g., processing, memory, network, and or power capacity) due to service failures and/or underperformance. In practice, this is problematic because services are complicated, involving many different computational resources that need to be specifically configured to operate with one another to effectuate the service.

In other techniques, services are launched without their operational readiness being sufficiently quantified, and the performance of the computational resources that constitute the services are not properly evaluated against their respective targets. The embodiments herein overcome these limitations by proactively determining the operational readiness of the computing resources prior to service launch, as well as measuring the actual performance of the computational resources against performance targets after launch. This information can be displayed to users along with a service map of the service so that the user can readily obtain information related to the effectiveness and efficiency of the service. Additionally, the standardization of the information and how it is displayed facilitates use of common rectification procedures when issues occur. This results in several advantages.

First, pre-launch checks allow services to only power up the required components and subsystems when necessary, rather than bringing up the entire computing infrastructure. For instance, background processes that consume power but don't contribute to the operational readiness can remain inactive until needed, leading to significant power savings, especially in large-scale deployments.

Second, by obtaining real-time performance data of computing resources that constitute the service, potential issues such as hardware degradation or software inefficiencies can be detected early. This enables proactive maintenance, reducing the likelihood of unexpected failures that can cause significant resource wastage. For example, technicians can gain visibility when performance targets of upstream computing resources are unmet due to underperforming downstream computing resources. Preventing downtime not only facilitates continuous service availability but also improves the use of related resources, such as processing, memory, network, and or power capacity.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

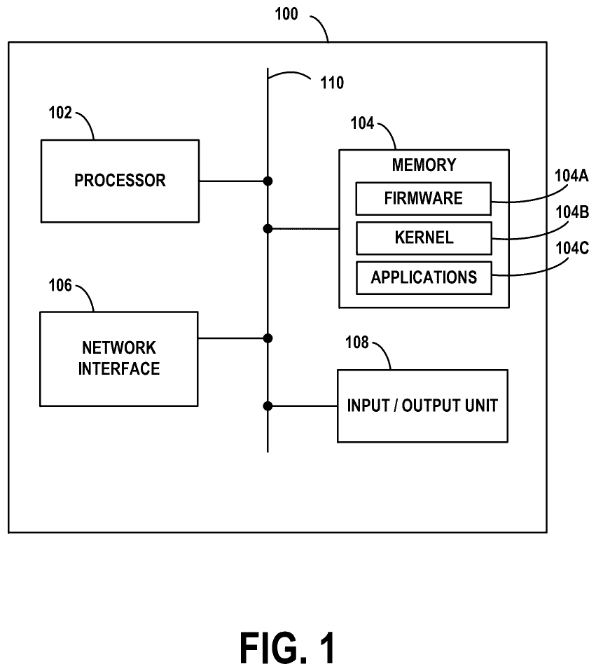

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

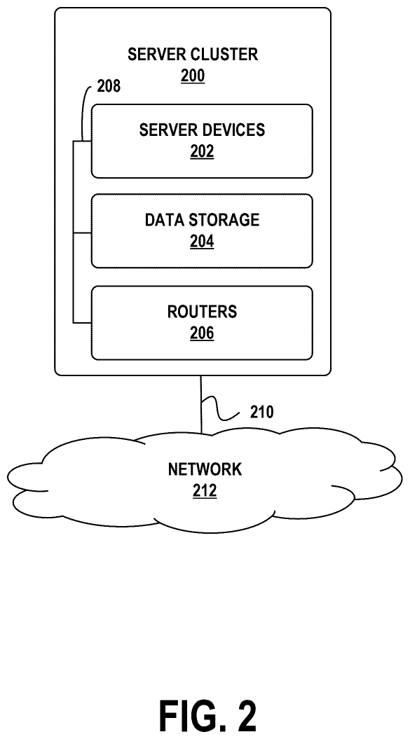

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

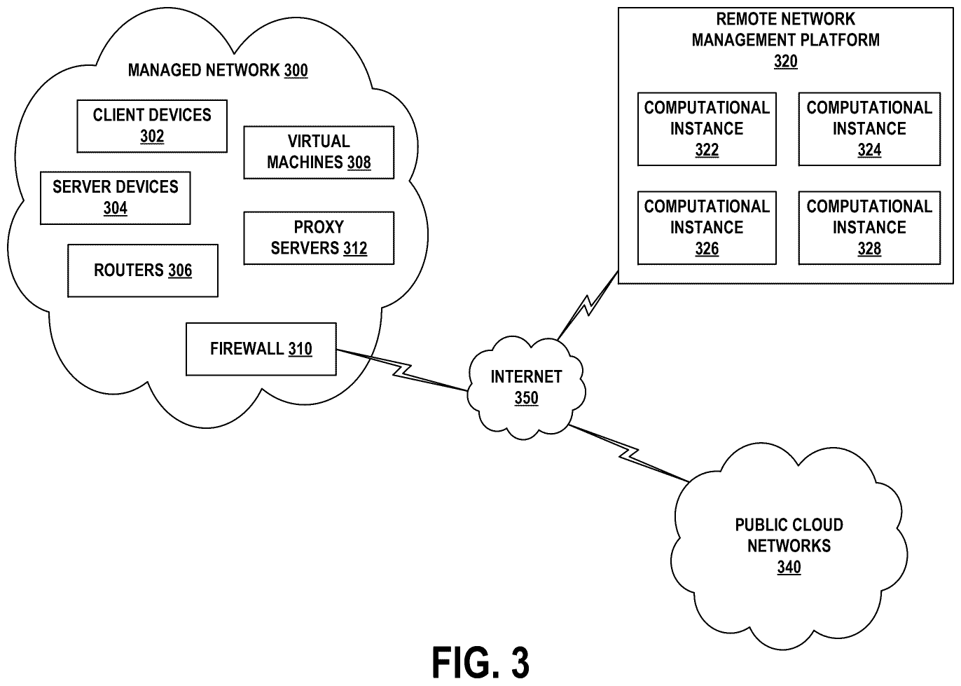

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

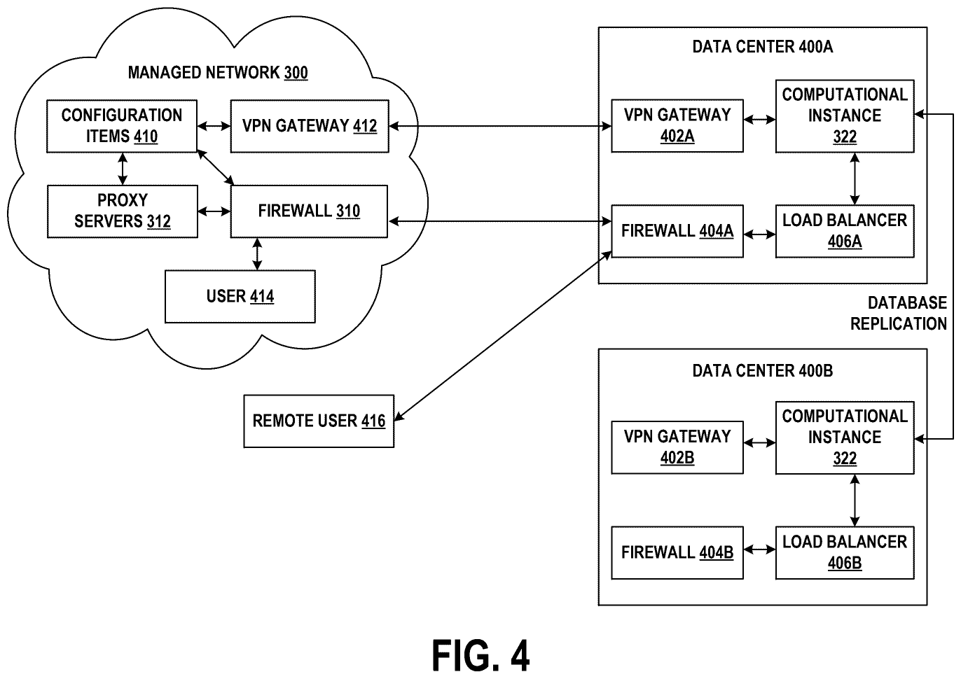

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

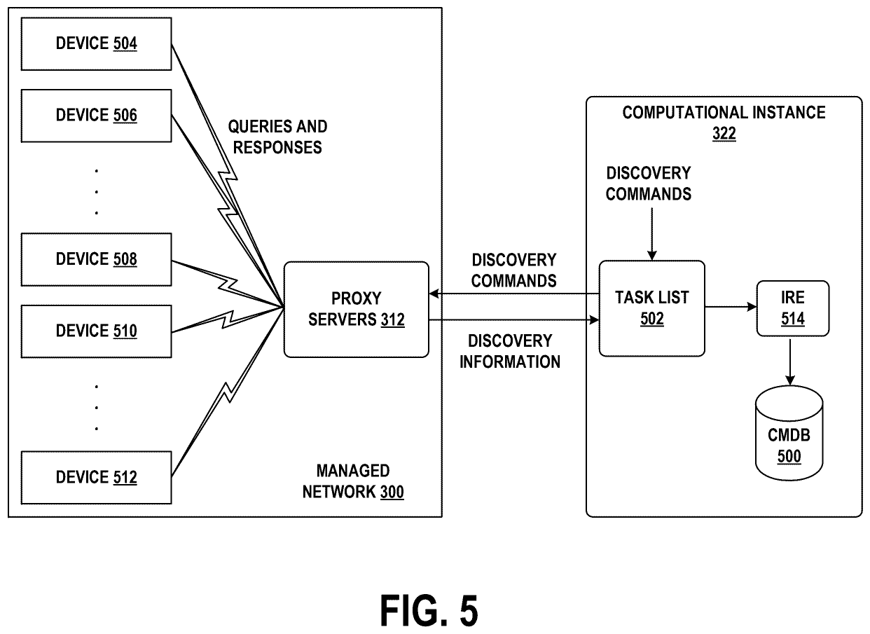

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Service Mapping and Service Maps

Service mapping refers to software executing on remote network management platform 320 or another platform that can identify interdependencies between computing devices, software applications, and/or other components deployed within a managed network or accessible to the managed network (e.g., disposed within a public cloud network used by the managed network). In doing so, a service mapping application may rely on horizontal, vertical, or top-down discovery to identify the computing devices, software applications, and/or other components, and record them as configuration items. Then, the service mapping application may employ a pattern-based approach, where it uses predefined discovery patterns to determine how services involving various configuration items are arranged and operate. For a given service, this may involve identifying one or more entry points through which client devices access the service. As noted above, these patterns can be extensive and cover a wide range of technologies, including servers, databases, middleware, and remote cloud-based infrastructure.

The service mapping application can generate a representation of the operational relationships between configuration items as a service map. Such a service map can be used to visualize the flow of data and interactions involving these configuration items, and may provide graphical representations of their service architecture. This visualization can be dynamic and thus be updated in real-time as changes occur in the managed network and elsewhere. In this fashion, the service map typically reflects the current state of the service architecture.

The service mapping application can be integrated with other modules of remote network management platform 320. For example, the data collected and produced by the service mapping application, including any service maps, can be stored in CMDB 500. This provides a source of ground truth for service maps that can be used by other applications such as incident management, change management, event management, and root cause analysis, just to name a few.

Moreover, the service mapping application can play a role in enhancing the effectiveness of IT operations. By having a detailed understanding of service architectures, IT administrators (as well as automated procedures) can quickly identify and resolve issues, plan changes more effectively (by understanding which configuration items might be impacted by a change), and minimize the risk of unintended consequences. This leads to improved service availability and performance throughout network 300.

Nonetheless, the evaluation and approval of service maps can be a lengthy process involving a number of manual steps. While an initial draft service map may be created by the service mapping software, this service map may remain in a partial and unapproved state until it is completed, tested, and validated. Thus, once the initial service map is created, a subject matter expert who has in-depth knowledge of specific areas relating to the service map's content (e.g., the attributes, arrangement, and operation of its configuration items) may review the service map. This review can include adding and/or removing configuration items and relationships therebetween, as well as checks for accuracy regarding these configuration items and relationships. Functional testing may also be carried out to validate the service map. This can involve simulating various scenarios (like service outages, changes, etc.) to ensure that the service map accurately reflects the impacts and dependencies involved in these scenarios.

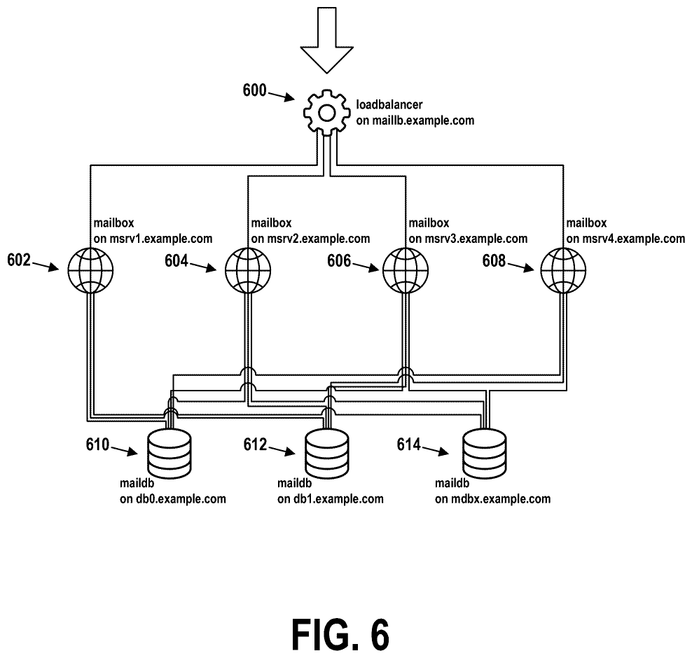

For purposes of example, FIG. 6 provides a service map including configuration items and relationships that make up an email service that supports redundancy and high-availability. This service map may have been initially generated by either pattern-based discovery, automated service suggestions (identifying potential application fingerprints or identifiers based on discovered processes—e.g., executing programs—within a managed network or cloud network), or predictive intelligence (using information from various sources—e.g., CMDB 500 as well as incident, change request, and/or log files or databases—and/or network traffic patterns to identify possible relationships between configuration items), and may have been manually edited to some extent. Both automated service suggestion and predictive intelligence may employ machine learning to generate candidate service maps. In any case, the service map may be represented in a manner that can be displayed on the screen of a computing device.

The nodes in the service map (i.e., nodes 600, 602, 604, 606, 608, 610, 612, and 614) represent applications operating on computing devices. Visually, these nodes may take the form of icons related to the respective functions of the applications or computing devices. The edges in the service map represent relationships between the nodes (e.g., “is hosted on”, “runs on”, “depends on”, or “used by”), though specific labeling of relationships is omitted from FIG. 6 to avoid clutter. For purposes of the internal representation and manipulation thereof, the visual depictions of nodes as icons and edges as lines is not relevant—other visual depictions may be used.

The entry point to the email service, as designated by the large downward-pointing arrow, may be load balancer 600 (“loadbalancer”). Load balancer 600 may be represented with a gear icon, and may operate on a device with host name maillb.example. com. This host name, as well as other host names herein, may be a partially-qualified or fully-qualified domain name in accordance with DNS domain syntax. Alternatively, IP addresses or other identifiers can be used.

Load balancer 600 may distribute incoming requests across mailbox applications 602, 604, 606, and 608 (“mailbox”) operating on mail server devices msrv1.example.com, msrv2.example.com, msrv3.example.com, and msrv4.example.com, respectively. These mail server devices may be represented by globe icons on the service map. Connectivity between load balancer 600 and each of mailbox applications 602, 604, 606, and 608 is represented by respective edges.

Mailbox applications 602, 604, 606, and 608 may, for instance, respond to incoming requests for the contents of a user's mail folder, for the content of an individual email message, to move an email message from one folder to another, or to delete an email message. Mailbox applications 602, 604, 606, and 608 may also receive and process incoming emails for storage by the email service. Other email operations may be supported by mailbox applications 602, 604, 606, and 608. For sake of example, it may be assumed that mailbox applications 602, 604, 606, and 608 perform essentially identical operations, and any one of these applications may be used to respond to any particular request.

The actual contents of users' email accounts, including email messages, folder arrangements, and other settings, may be stored in one or more of mail database applications 610, 612, and 614 (“maildb”). These applications may operate on database server devices db0.example.com, db1.example.com, and mdbx.example.com, which are represented by database icons on the service map. Connectivity between mailbox applications 602, 604, 606, and 608 and each of mail database applications 610, 612, and 614 also is represented by respective edges.

Mailbox applications 602, 604, 606, and 608 may retrieve requested data from mail database applications 610, 612, and 614, and may also write data to mail database applications 610, 612, and 614. The data stored by mail database applications 610, 612, and 614 may be replicated across all of the database server devices.

As an example of the operation of the email service depicted by the service map of FIG. 6, an incoming email message may arrive at load balancer 600. This email message may be addressed to an email account (e.g., user@example.com) supported by the email service. Load balancer 600 may select one of mailbox applications 602, 604, 606, and 608 to store the email message. For instance, load balancer 600 may make this selection based on a round-robin procedure, the loads (e.g., CPU, memory, and/or network utilization) reported by mailbox applications 602, 604, 606, and 608, randomly, or some combination thereof.

Assuming that load balancer 600 selects mailbox application 604, load balancer 600 then transmits the email message to mailbox application 604. Mailbox application 604 may perform any necessary mail server functions to process the email message, such as verifying that the addressee is supported by the email server, validating the source of the email message, running the email message through a spam filter, and so on. After these procedures, mailbox application 604 may select one of mail database applications 610, 612, and 614 for storage of the email message. Similar to load balancer 600, mailbox application 604 may make this selection based on various criteria, including load on mail database applications 610, 612, and 614.

Assuming that mailbox application 604 selects mail database application 610, mailbox application 604 then transmits the email message to mail database application 610. Mail database application 610 may perform any necessary mail database functions to process and store the email message. For instance, mail database application 610 may store the message as a compressed file in a file system, and update one or more database tables to represent characteristics of the email message (e.g., the sender, the size of the message, its importance, where the file is stored, and so on).

When a mail client application (not shown) requests a copy of the email message, this request may also be received by load balancer 600. Load balancer 600 may select one of mailbox applications 602, 604, 606, and 608 to retrieve the email message. This selection may be made according to various criteria, such as any of those discussed above. Assuming that load balancer 600 selects mailbox application 608, mailbox application 608 then selects one of mail database applications 610, 612, and 614. Assuming that mailbox application 608 selects mail database application 612, mailbox application 608 requests the email message from mail database application 612.

Since data is replicated across mail database applications 610, 612, and 614, mail database application 612 is able to identify and retrieve the requested email message. For instance, mail database application 612 may look up the email message in a database table, from the table determine where the email message is stored in its file system, find the email message in the file system, and provide the email message to mailbox application 608. Mailbox application 608 may then transmit the email message to the mail client application.

The arrangement of the service map in FIG. 6 may vary. For example, more or fewer load balancers, mailbox applications, mail database applications, as well as their associated devices, may be present. Furthermore, other devices may be included, such as storage devices, routers, switches, and so on. Additionally, while FIG. 6 is focused on an example email service, similar network graphs may be generated and displayed for other types of services, such as web services, remote access services, automatic backup services, content delivery services, and so on.

### VIII. Operational Readiness and Operational Correctness of Services

The implementations herein involve new aspects and improvements to the operational readiness and operational correctness of services. As noted above, a service may involve a collection of computing resources, such as server devices and other computing infrastructure, applications, databases, and/or network elements, that work together to provide specific capabilities to users, applications, or other services. For example, the load balancer, mailbox applications, and mail database servers of FIG. 6 may be computing resources that collectively provide an email service to users.

However, deploying and operating services in a network (or across networks) can be involved and error-prone procedures due to the number of computing resources that provide the service as well as the relationships between these computing resources. For example, if a computing resource relied on by the service is not present (e.g., due to not being properly deployed or having crashed) or is misconfigured (e.g., with an invalid network address or other setting), the service is unlikely to operate correctly or at all. Consequently, the uptime of the service (e.g., the percentage of time that a service is operational and available over a defined period that is typically in terms of hours, days, or months) can be lower than desired.

Further, if a service in operation fails, it may be difficult to identify the root cause (e.g., the computing resource or resources that are not operating correctly and are the cause of the failure). This results in the mean-time-to-resolution (MTTR) of getting the service back into an operational states being higher than desired. Here, the MTTR may measure the average time required to diagnose, repair, and restore operation of a service (e.g., calculated by summing the total downtime over a specific period and dividing it by the number of discrete incidents impacting the service that occurred within that period).

Here, the term “network” generally refers to managed network 300 or a similar network with similar arrangements of computing resources. However, “network” may refer to any type of network in which services are deployed.

### A. Operational Readiness

Operational readiness involves a set of procedures and/or computing operations that ultimately specify the readiness of a service for deployment. Doing so may involve a number of steps including: obtaining a service map of the service (e.g., by way of the service mapping procedures described above or some other means), identifying a readiness of each of the computing resources constituting the service (e.g., by performing a predefined list of checks on the computing resources), and generating a display of the readiness of each computing resource in the service map (e.g., for display on a graphical user interface). Particularly, the respective readiness of each computing resource can be considered in various combinations to determine a health score for the service that is an indicator of the service's overall operational readiness. Such operational readiness procedures are typically performed prior to launching or initiation of the service, but could be performed after launch or initiation of the service. The procedures may be defined in database tables, executable or interpretable code, and/or workflow logic, for example.

The list of checks for a given computing resource may vary based on the type of computing resource, its role in providing the service, and/or other operational needs. Examples of checks are provided below for purposes of illustration, along with how the check might be performed. But more, fewer, and/or other checks can be used.

Check: Does the computing resource have a configuration item entry in the CMDB. The CMDB can be searched based on a unique identifier or unique combination of identifiers expected to be present in the attributes of configuration items representing the computing resource.

Check: Does the configuration item entry for the computing resource have relationship entries in the CMDB to at least one other computing resource in the service. The CMDB can be searched for relationships between the computing resource and other computing resources in the service.

Check: Does the configuration item entry for the computing resource have valid definitions for all required or important attributes in the CMDB (e.g., name, type, class, serial number, IP address, netmask, gateway, location, etc.). The CMDB can be searched for the configuration item, and then the configuration item can be checked for presence and/or correctness of attributes.

Check: Is the computing resource reachable over the network. The computing resource can be probed, e.g., by sending a ping request to it IP address.

Check: Is the computing resource configured with the correct version of its operating system and/or firmware. Optionally, the presence of certain patches and/or updates can also be considered. The CMDB can be checked for this or the computing resource can be probed by way of a remote login.

Check: Is the computing resource configured with the correct security capabilities (e.g., firewall and/or antivirus are present and properly configured, access control lists are correct). The CMDB can be checked for this or the computing resource can be probed by way of a remote login.

Check: Is performance monitoring configured properly for the computing resource. Performance monitoring may entail periodically or from time to time reading performance metrics such as processor utilization, main memory utilization, and/or long-term storage (e.g., disk) utilization. The performance metrics may be gathered based on reporting from the computing resource (e.g., in the form of logs, events, and/or notifications) and/or remote probes from one or more separate monitoring applications.

Check: Are all third-party integrations configured and functioning as expected. These third-party integrations are between the network and one or more remote services provided by an entity other than the one that operates the network. For example, the remote services may be accessible by way of web-based interfaces (e.g., representation state transfer (REST) interfaces). The computing resources can be checked for third-party integrations by verifying the presence and accuracy of configuration settings (e.g., API keys, endpoint URLs, and/or authentication credentials), reachability testing of the remote service from the computing resources (e.g., ping testing and/or API testing), checking logs for output indicating that the third-party integrations are operating as expected, and so on.

Check: Monitoring, traceability, and/or observability are active for the service. Monitoring may involve the testing of systems, services, and applications to determine whether they are functioning as expected. It typically includes tracking key performance indicators (KPIs), system health metrics, and service availability, and may be achieved through various tools and features that allow users to set up alerts, dashboards, and reporting. Traceability may refer to the ability to track and understand the flow of data and changes within a system. Traceability allows users to see who made changes to specific records, when those changes were made, and what the changes were. Observability may involve involve collecting and analyzing data from various sources, such as logs, metrics, and traces, to gain a comprehensive understanding of a service's behavior. This allows for proactive identification of issues and more effective root cause analysis.

Check: are one or more escalation paths defined for when problems are reported about the service. An escalation path may involve a series of email addresses, phone numbers, messaging application identifiers, or other contact information of individuals or groups. Incidents, problems, or detected errors relating to the service and of more than a threshold severity may cause a system to notify the applications or persons associated with the contact information. The persons may be on-call for certain periods of time and the system may contact them in accordance with their schedules.

Notably, the checks provided herein are not an exhaustive list. These and other checks may involve searching a CMDB, filesystem, configurable settings, log files, etc. Further, two or more checks can be combined in various ways by applying Boolean, arithmetic, and/or regular expressions. In some cases, these expressions can be built iteratively by way of a guided user interface.

For example, a Boolean expression to check that the IP address and operating system of a computing resource is properly configured could be “myCI.IP_address=10.172.13.1 AND myCI.os=myOSv7.2”. This example is of how a check could be performed by way of searching the configuration item of the computing resources. In other scenarios, script-based remote login access to the computing resource may be used to query the computing resource directly.

In any event, each computing resource in a service may be associated with a list of checks. Some of these checks in the list may be a single check (such as checking an IP address), while others may be compound (such as checking an IP address and an operating system using Boolean, arithmetic and/or regular expressions).

In some cases, each check in the list may be associated with a weight indicating its importance. These weights may sum to 1.0 or some other value. The weights allow assignment of a degree of completeness to a computing resource based on the weights of the checks that pass. For instance, in a list with two checks, one for “myCI.IP_address=10.172.13.1” and another for “myCI.os=myOSv7.2”, the check of the IP_address attribute may be give a weight of 0.8 and the check of the os attribute may be given a weight of 0.2. This indicates that the computing resource exhibits a high degree of operational readiness when the IP_address is set to the proper value, even if the os attribute is set to a version other than what is desired. In other words, the computing resource has an operational readiness of 80% when the IP_address is set to the proper value and the os attribute is set to an undesired value.

In general, the number of checks for a given computing resource may scale with the criticality or importance of the computing resource to one or more services. As an example, a database server supporting multiple services may have a more extensive list of checks than a web server supporting just one low-importance service. This reflects the notion that more checks should take place for a critical or important service than for a less critical or less important service. The ratio of checks passed to overall checks can be used to score the operational readiness of each computing resource.

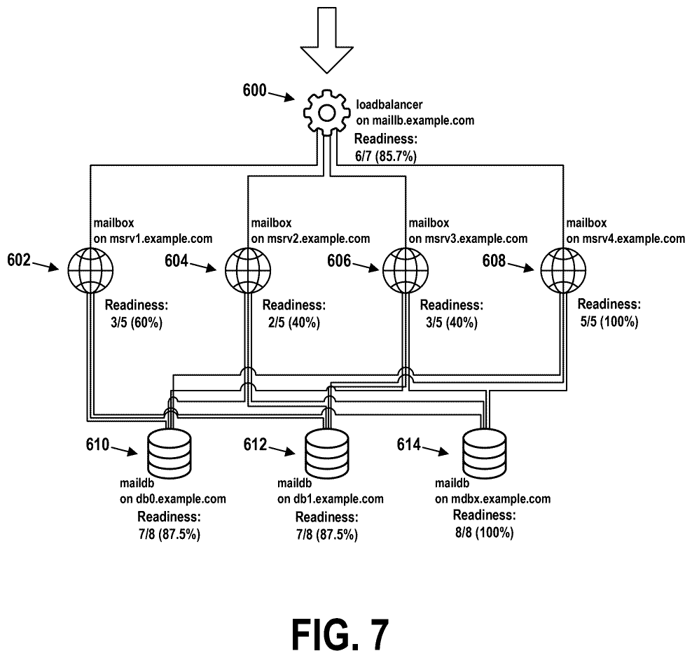

FIG. 7 provides an updated version of FIG. 6, with operational readiness indicators for each of the computing resources. Here, it is assumed that load balancer 600 has 7 checks, the mailbox applications have 5 checks each, and the mail database applications have 8 check each. It is assumed, for sake of simplicity, that equal weights are given to all of the checks per computing resource and that these weights sum to 1.0.

In FIG. 7, load balancer 600 has passed 6 of 7 checks and thus has an operational readiness of 85.7%. Mailbox application 602 has passed 3 of 5 checks and thus has an operational readiness of 60%. Mailbox application 604 has passed 2 of 5 checks and thus has an operational readiness of 40%. Mailbox application 606 has passed 3 of 5 checks and thus has an operational readiness of 60%. Mailbox application 608 has passed 5 of 5 checks and thus has an operational readiness of 100%. Mail database application 610 has passed 7 of 8 checks and thus has an operational readiness of 87.5%. Mail database application 612 has passed 7 of 8 checks and thus has an operational readiness of 87.5%. Mail database application 614 has passed 8 of 8 checks and thus has an operational readiness of 100%. In some cases, these percentages or other representations of operational readiness may be referred to as health scores.

FIG. 7 is a visual representation of operational readiness that can be displayed, for example, on a graphical user interface. With it, a user can easily identify the operational readiness of each computing resource.

In some cases, there may be one or more thresholds or cutoff values that define different levels of operational readiness. For example, computing resources with an operational readiness of 100% may be given a status of “full readiness”, computing resources with an operational readiness of at least 70% but less than 100% may be given a status of “partial readiness”, and computing resources with an operational readiness of less than 70% may be given a status of “limited readiness”. These different levels of readiness may be displayed as a fraction and/or percentage as shown, or color coded (e.g., green for full readiness, yellow for partial readiness, and red for limited readiness). Other visual techniques for emphasizing and/or differentiation between levels of readiness may be used. Regardless, in FIG. 7, two computing resources have full readiness, three have partial readiness, and three have limited readiness.

With the information in FIG. 7, the user can rapidly determine which computing resources have failed checks and either investigate why or decide that the computing resource can be used to provide the service even if one or more of its checks have failed. This is in stark contrast to previous service deployments, which would involve launching the service without determining the operational readiness of each of its computing resources. In these situations, service failures were common because at least one computing resource would not have a sufficient level of operational readiness. However, technicians would often have to go through extensive debugging and tracing exercises to identify the computing resources(s) lacking operational readiness. As a consequence, both the uptime of the service and the MTTR of the service were negatively impacted. The implementations herein increase the uptime and decrease the MTTR because most deficiencies in operational readiness can be identified and corrected prior to launching the service.

For instance, the overall operational readiness of various services in a network (e.g., the mean or median operational readiness or some other measure of central tendency for the computing resources that constitute the service) can be represented as line items. These line items can be sorted into ascending or descending order and presented on a graphical user interface. Additionally, each service may be assigned a criticality that represents the service's importance to the network. These criticalities can also be sorted into ascending or descending order and presented on a graphical user interface. This allows users to easily identify relatively critical services that have relatively low operational readiness.

Moreover, the system can automatically notify applications or persons of any computing resources below a predetermined level of operational readiness. This facilitates a proactive approach to operating the service in which misconfigurations and/or other errors can be identified and addressed prior to service launch or initiation.

### B. Operational Correctness

Operational correctness tests a service in a different manner than the service readiness features described herein. Particularly, operational readiness involves procedures that determine whether computing resources constituting the service pass certain pre-defined checks that cumulatively represent the service's readiness to be put in operation. In contrast, operational correctness measures whether the service meets certain predefined performance targets while in operation.

In particular, these performance targets can be in terms of uptime, MTTR, and/or some other metric. For example, an alternative performance target could be based on whether a count of reported errors that relate to the service are within a predefined error budget. The discussion below uses uptime for purposes of example. Other performance targets can be used instead.

Operational correctness involves two distinct but related procedures: (i) determining dependencies between computing resources in a service map and whether the dependency structure allows performance targets to be achieved, and (ii) tracking actual performance of the computing resources and comparing these to the performance targets. The performance targets for each computing resource may be based on best practices, a service-level objective, or some other measure. For instance, a given computing resource may have a performance target of an uptime of 99.9%. This means that the computing resource can be unavailable or inoperable for its intended purpose for no more than 1 minute 26 seconds per day, 10 minutes 4.8 seconds per week, 43 minutes 28 seconds per month (assuming an average month is approximately 30.4 days), and so on.

Nonetheless, the effective availability of a computing resource may be impacted by its dependencies as indicated in a service map for example. Notably, if the given computing resource with a performance target of 99.9% uptime is dependent on another computing resource with a lower performance target (e.g., 99.0%), then it is possible that the given computing resource will be unable to achieve its performance target even if the other computing resource does. In other words, the dependency results in the other computing resource needing to have a performance target of at least 99.9% in order for the performance targets of the service as a whole to be met.

Moreover, the dependencies in a service may can be complex. The given computing resource with the performance target of 99.9% may be dependent upon two other computing resources both being available. In this case, both of the two other computing resources need a performance target of approximately 99.95% in order for the performance target of the computing resource to be met. This multiplicative relationship between the performance targets of computing resources may be referred to as a conjunctive relationship—both of the other two computing resources require an uptime such that they are collectively available 99.9% of the time.

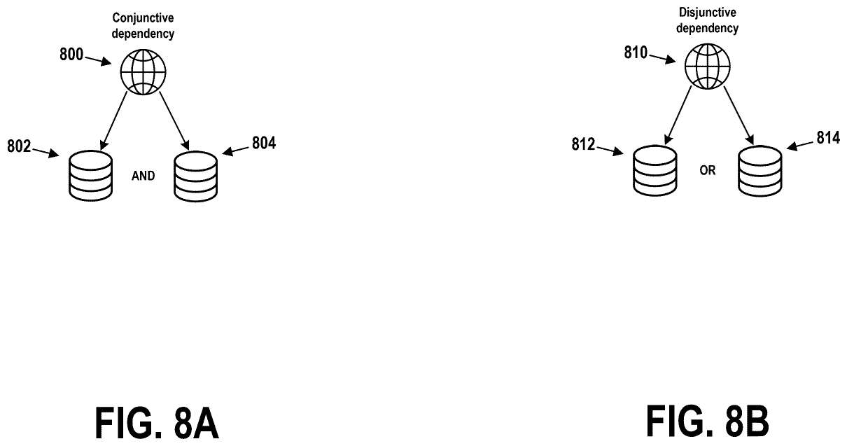

A simple example of this is shown in FIG. 8A. Server 800 is dependent on database 802 and database 804 in order to operate. Thus, database 802 and database 804 must each have a performance target sufficiently higher than that of server 800 so that the performance target of server 800 is achievable. These multiplicative concepts can be applied to more complicated dependency arrangements.

In other situations, a given computing resource may be dependent on at least one of n other computing resources being available. For instance, the n other computing resources may be redundant with one another and arranged so that any one that is available can serve the given computing resource. This additive relationship between the performance targets of computing resources may be referred to as a disjunctive relationship.

A simple example of this is shown in FIG. 8B. Server 810 is dependent on database 812 or database 814 in order to operate. Thus, database 812 and database 814 must each have a performance target such that they collectively support the performance target of server 800 being achievable. In the system of FIG. 8B, this means that the performance target of server 810 must be achievable when database 812 is unavailable but database 814 is available, database 812 is available but database 814 is unavailable, and both databases are available. This can be expressed as the following equation:

$$( PG 812 ) ( PG 814 ) + ( PG 812 ) ( 1 - PG 814 ) + ( 1 - PG 812 ) ( PG 814 ) \geq PG 810$$

Here, PG810 is the performance target of server 810, PG812 is the performance target of database 812, and PG814 is the performance target of database 814. So long as this equation is satisfied, the performance target of server 810 can be met. This equation can be generalized for situations in which there are n redundant databases.

Given a service map defining dependencies between computing resources and the performance targets of each of the computing resources, the system can determine (e.g., using the conjunctive and disjunctive techniques above, whether the performance targets of various computing resources can be met. If such a performance target cannot be met, the system may flag the computing resource in question on a display of the service map, and/or alert one or more applications or users.

Furthermore, the uptimes of the computing resources in the service map may be monitored dynamically and/or on an ongoing basis. The uptimes may be measured in various ways. For example, ping tests can check the reachability and responsiveness of a computing resource from another device. Another approach is through uptime monitoring software, which can use probes or other mechanisms to tracks the computing resource's status, recording any downtime and generating reports on availability over time. Log analysis is also possible, where system logs of the computing resource are retrieved and/or reviewed to identify any periods of inactivity or system failures. Additionally, hardware sensors can be employed to monitor the computing resource's physical health, such as temperature or power supply status, which can indirectly indicate uptime by determining whether the computing resource remains within operational parameters. Alone or in combination, these methods can provide an ongoing representation of the device's uptime.

Regardless of how they are determined, the uptimes of each computing resource can be displayed on a service map along with the performance target for the computing resource. This allows rapid determination of whether performance targets are being achieved. Further, the uptime of each computing resource maybe compared to its respective performance target. If the uptime is less than that of the performance target, the system may flag the computing resource in question on a display of the service map, and/or alert one or more applications or users.

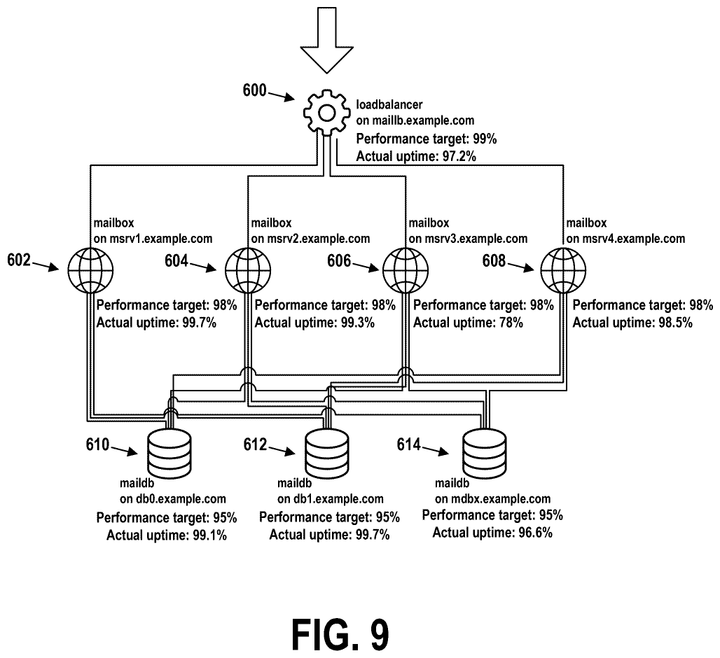

FIG. 9 depicts a service map displaying performance targets and actual uptimes of various computing resources. It is assumed that load balancer 600 is disjunctively dependent on the mailbox applications 602, 604, 606, and 608, and that each of these mail application servers are disjunctively dependent on mail database applications 610, 612, and 614. While these disjunctive relationships are such that the performance targets of the all computing resources can be achieved given the performance targets of their dependencies, there are two computing resources for which the actual uptime does not meet the performance target—notably, load balancer 600 and mailbox application 606. As noted, the system may highlight these on a display of the service map and/or notify an application or user of the discrepancies.

As noted above, the uptimes of computing resources are used herein for example. Other types of performance targets, such as those based on MTTR or error count could be used instead of or in addition to uptime.

### C. Dynamic Discovery of Computing Resources

The implementations herein support dynamic discovery of computing resources that constitute a service. As noted, discovery may be performed periodically (e.g., once a day or once a week). Thus, the computing resources that constitute the service may change after discovery completes. If this is the case, the system may notify one or more applications or users. If any new computing resources are added to the service, the system may check the operational readiness status and the operational correctness status of these computing resources. The applications or users may be further notified if any of these computing resources are: (i) not configured to support operational readiness, (ii) exhibit an operational readiness below a predefined threshold, (iii) are not configured for operational correctness, or (iv) do not meet their operational correctness performance targets.

### IX. Example Operations

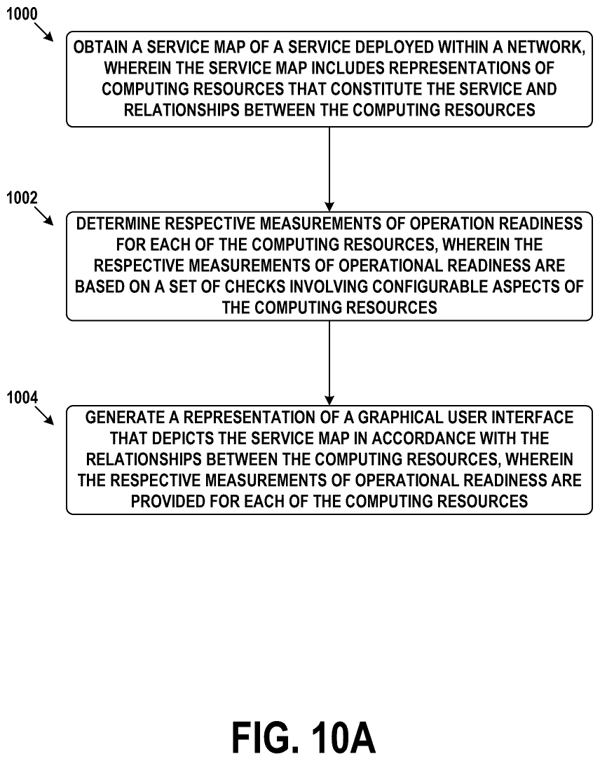

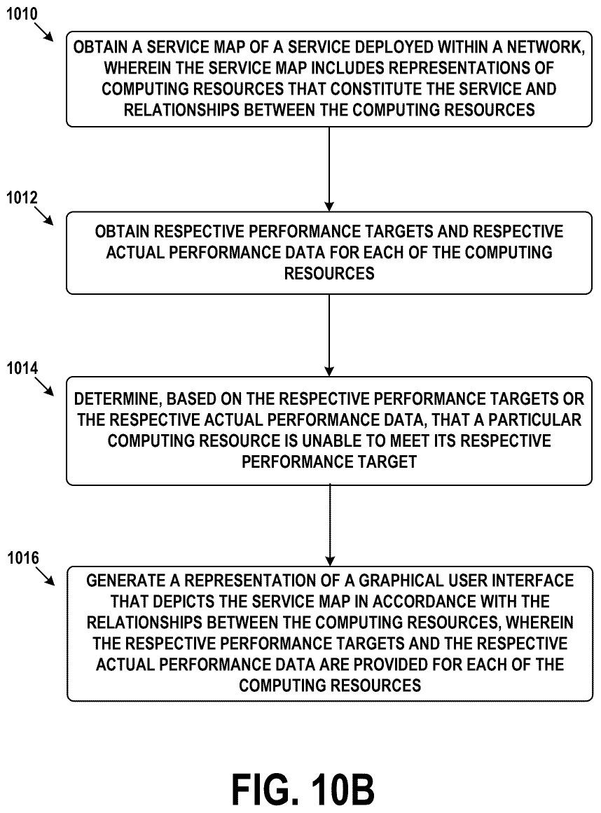

FIGS. 10A and 10B are flow charts illustrating example embodiments. The processes illustrated by FIGS. 10A and 10B may be carried out by a computing device, such as computing device 100, and/or a cluster of computing devices, such as server cluster 200. However, the processes can be carried out by other types of devices or device subsystems. For example, the processes could be carried out by a computational instance of a remote network management platform or a portable computer, such as a laptop or a tablet device.

The embodiments of FIGS. 10A and 10B may be simplified by the removal of any one or more of the features shown therein. Further, these embodiments may be combined with features, aspects, and/or implementations of any of the previous figures or otherwise described herein.

Block 1000 may involve obtaining a service map of a service deployed within a network, wherein the service map includes representations of computing resources that constitute the service and relationships between the computing resources.

Block 1002 may involve determining respective measurements of operational readiness for each of the computing resources, wherein the respective measurements of operational readiness are based on a set of checks involving configurable aspects of the computing resources.

Block 1004 may involve generating a representation of a graphical user interface that depicts the service map in accordance with the relationships between the computing resources, wherein the respective measurements of operational readiness are provided for each of the computing resources.

The operations of block 1004 and other steps facilitate proactively determining the operational readiness of the computing resources prior to service launch. These pre-launch checks allow services to only power up the required components and subsystems when necessary, rather than bringing up the entire computing infrastructure. As a result, processor, memory, network, and/or power consumption is reduced.

In some implementations, the computing resources are each assigned respective types, and the set of checks includes different checks for different types of the computing resources.

In some implementations, each of the checks is assigned a respective weight, and the respective measurements of operational readiness are based applying the respective weights to the checks.

In some implementations, the checks include one or more of whether a computing resource: has an entry in a CMDB, has one or more relationship entries in the CMDB, has valid definitions for at least a subset of attributes in its entry in the CMDB, is reachable by way of the network, or is configured with a predefined operating system or firmware version.

Some implementations may involve: obtaining respective performance targets and respective actual performance data for each of the computing resources; determining, based on the respective performance targets or the respective actual performance data, that a particular computing resource is unable to meet its respective performance target; and generating a second representation of a second graphical user interface that depicts the service map in accordance with the relationships between the computing resources, wherein the respective performance targets and the respective actual performance data are provided for each of the computing resources.

Some implementations may involve: providing, to a client device, the representation of the graphical user interface, wherein reception of the representation of the graphical user interface causes the client device to display the graphical user interface.

Some implementations may involve: the representation of the graphical user interface emphasizes the computing resources with the respective measures of operational readiness that are below a predefined threshold value.

Block 1010 for FIG. 10B may involve obtaining a service map of a service deployed within a network, wherein the service map includes representations of computing resources that constitute the service and relationships between the computing resources.

Block 1012 may involve obtaining respective performance targets and respective actual performance data for each of the computing resources.

Block 1014 may involve determining, based on the respective performance targets or the respective actual performance data, that a particular computing resource is unable to meet its respective performance target.

Block 1016 may involve generating a representation of a graphical user interface that depicts the service map in accordance with the relationships between the computing resources, wherein the respective performance targets and the respective actual performance data are provided for each of the computing resources.

Operations of block 1016 and other steps involves comparing performance targets of related computing resources to one another as well as comparing the actual performance of the computational resources against the performance targets. This information can be displayed to users along with a service map of the service so that the user can readily obtain information related to the effectiveness and efficiency of the service. By obtaining real-time performance data of computing resources that constitute the service, potential issues such as hardware degradation or software inefficiencies can be detected early. This enables proactive maintenance, reducing the likelihood of unexpected failures that can cause significant resource wastage. Preventing downtime not only facilitates continuous service availability but also improves the use of related resources, such as processing, memory, network, and or power capacity.

In some implementations, determining that the particular computing resource is unable to meet its respective performance target comprises determining that the particular computing resource is unable to meet its respective performance target given the respective performance targets of one or more other computing resources.

Some implementations may involve: determining, based on the respective performance targets and the respective actual performance data, that a second particular computing device has not met its respective performance target given its respective actual performance data.

In some implementations, the representation of the graphical user interface emphasizes the computing resources unable to meet their respective performance targets, including the particular computing resource.

In some implementations, the respective performance targets include uptime, MTTR, or error counts of the computing resources. Other performance targets could include latency (e.g., the average or median time taken for one or more computing resources to perform a transaction), saturation (e.g., how much of a given computing resource is being consumed at a time), and/or other measures of availability.

In some implementations, the particular computing device depends on two or more other computing resources in a conjunctive manner, and determining that the particular computing resource is unable to meet its respective performance target comprises determining that an unachievable multiplicative relationship exists between performance targets of the two or more other computing resources and the respective performance target of the particular computing resource.

In some implementations, the particular computing device depends on two or more other computing resources in a disjunctive manner, and determining that the particular computing resource is unable to meet its respective performance target comprises determining that an unachievable additive relationship exists between performance targets of the two or more other computing resources and the respective performance target of the particular computing resource.

Some implementations may involve: determining respective measurements of operational readiness for each of the computing resources, wherein the respective measurements of operational readiness are based on a set of checks involving configurable aspects of the computing resources; and generating a second representation of a second graphical user interface that depicts the service map in accordance with the relationships between the computing resources, wherein the respective measurements of operational readiness are provided for each of the computing resources.

Some implementations may involve: providing, to a client device, the representation of the graphical user interface, wherein reception of the representation of the graphical user interface causes the client device to display the graphical user interface.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a service map of a service deployed within a network, wherein the service map includes representations of computing resources that constitute the service and relationships between the computing resources;
determining respective measurements of operational readiness for each of the computing resources, wherein the respective measurements of operational readiness are based on a set of checks involving configurable aspects of the computing resources; and
generating a representation of a graphical user interface that depicts the service map in accordance with the relationships between the computing resources, wherein the respective measurements of operational readiness are provided for each of the computing resources.

2. The method of claim 1, wherein the computing resources are each assigned respective types, and wherein the set of checks includes different checks for different types of the computing resources.

3. The method of claim 1, wherein each of the checks is assigned a respective weight, and wherein the respective measurements of operational readiness are based applying the respective weights to the checks.

4. The method of claim 1, wherein the checks include one or more of whether a computing resource: has an entry in a configuration management database (CMDB), has one or more relationship entries in the CMDB, has valid definitions for at least a subset of attributes in its entry in the CMDB, is reachable by way of the network, or is configured with a predefined operating system or firmware version.

5. The method of claim 1, further comprising:
obtaining respective performance targets and respective actual performance data for each of the computing resources;
determining, based on the respective performance targets or the respective actual performance data, that a particular computing resource is unable to meet its respective performance target; and
generating a second representation of a second graphical user interface that depicts the service map in accordance with the relationships between the computing resources, wherein the respective performance targets and the respective actual performance data are provided for each of the computing resources.

6. The method of claim 1, further comprising:
providing, to a client device, the representation of the graphical user interface, wherein reception of the representation of the graphical user interface causes the client device to display the graphical user interface.

7. The method of claim 1, wherein the representation of the graphical user interface emphasizes the computing resources with the respective measures of operational readiness that are below a predefined threshold value.

8. A method comprising:
obtaining a service map of a service deployed within a network, wherein the service map includes representations of computing resources that constitute the service and relationships between the computing resources;
obtaining respective performance targets and respective actual performance data for each of the computing resources;
determining, based on the respective performance targets or the respective actual performance data, that a particular computing resource is unable to meet its respective performance target; and
generating a representation of a graphical user interface that depicts the service map in accordance with the relationships between the computing resources, wherein the respective performance targets and the respective actual performance data are provided for each of the computing resources.

9. The method of claim 8, wherein determining that the particular computing resource is unable to meet its respective performance target comprises determining that the particular computing resource is unable to meet its respective performance target given the respective performance targets of one or more other computing resources.

10. The method of claim 8, further comprising:
determining, based on the respective performance targets and the respective actual performance data, that a second particular computing device has not met its respective performance target given its respective actual performance data.

11. The method of claim 8, wherein the representation of the graphical user interface emphasizes the computing resources unable to meet their respective performance targets, including the particular computing resource.

12. The method of claim 8, wherein the respective performance targets include uptime, mean time to resolution (MTTR), or error counts of the computing resources.

13. The method of claim 8, wherein the particular computing device depends on two or more other computing resources in a conjunctive manner, and wherein determining that the particular computing resource is unable to meet its respective performance target comprises determining that an unachievable multiplicative relationship exists between performance targets of the two or more other computing resources and the respective performance target of the particular computing resource.

14. The method of claim 8, wherein the particular computing device depends on two or more other computing resources in a disjunctive manner, and wherein determining that the particular computing resource is unable to meet its respective performance target comprises determining that an unachievable additive relationship exists between performance targets of the two or more other computing resources and the respective performance target of the particular computing resource.

15. The method of claim 8, further comprising:
determining respective measurements of operational readiness for each of the computing resources, wherein the respective measurements of operational readiness are based on a set of checks involving configurable aspects of the computing resources; and
generating a second representation of a second graphical user interface that depicts the service map in accordance with the relationships between the computing resources, wherein the respective measurements of operational readiness are provided for each of the computing resources.

16. The method of claim 8, further comprising:
providing, to a client device, the representation of the graphical user interface, wherein reception of the representation of the graphical user interface causes the client device to display the graphical user interface.

17. A non-transitory computer-readable medium, having stored thereon program instructions that, upon execution by a computing system, cause the computing system to perform operations comprising:
obtaining a service map of a service deployed within a network, wherein the service map includes representations of computing resources that constitute the service and relationships between the computing resources;
obtaining respective performance targets and respective actual performance data for each of the computing resources;
determining, based on the respective performance targets or the respective actual performance data, that a particular computing resource is unable to meet its respective performance target; and
generating a representation of a graphical user interface that depicts the service map in accordance with the relationships between the computing resources, wherein the respective performance targets and the respective actual performance data are provided for each of the computing resources.

18. The non-transitory computer-readable medium of claim 17, wherein determining that the particular computing resource is unable to meet its respective performance target comprises determining that the particular computing resource is unable to meet its respective performance target given the respective performance targets of one or more other computing resources.

19. The non-transitory computer-readable medium of claim 17, wherein the particular computing device depends on two or more other computing resources in a conjunctive manner, and wherein determining that the particular computing resource is unable to meet its respective performance target comprises determining that an unachievable multiplicative relationship exists between performance targets of the two or more other computing resources and the respective performance target of the particular computing resource.

20. The non-transitory computer-readable medium of claim 17, wherein the particular computing device depends on two or more other computing resources in a disjunctive manner, and wherein determining that the particular computing resource is unable to meet its respective performance target comprises determining that an unachievable additive relationship exists between performance targets of the two or more other computing resources and the respective performance target of the particular computing resource.
